(19) United States
(12) Patent Application Publication
(10) Pub. No.: US 2023/0403755 A1
(43) Pub. Date: Dec. 14, 2023

(54) METHOD TO IMPROVE PHYSICAL NETWORK DESIGN BY ANALYZING SIGNAL STRENGTH AND ROAMING BEHAVIOR

(71) Applicant: KONINKLIJKE PHILIPS N.V., EINDHOVEN (NL)

(72) Inventors: Serverius Petrus Paulus PRONK, VUGHT (NL); Johannes Henricus Maria KORST, EINDHOVEN (NL); Marc André PETERS, VELDHOVEN (NL); Mauro BARBIERI, EINDHOVEN (NL)

(21) Appl. No.: 18/032,200

(22) PCT Filed: Oct. 13, 2021
(86) PCT No.: PCT/EP2021/078290

§ 371 Date: Apr. 17, 2023

Related U.S. Application Data
(60) Provisional application No. 63/094,375, filed on Oct. 21, 2020.

(51) Int. Cl. H04W 76/19; H04W 24/08; H04W 24/02; H04W 64/00

(52) U.S. Cl. CPC H04W 76/19; H04W 24/08; H04W 24/02; H04W 64/006; H04W 84/12

(57) ABSTRACT

A non-transitory computer readable medium (26) stores instructions executable by at least one electronic processor (20) to perform a method (100) of detecting issues with wireless connections. The method includes: receiving Wi-Fi roaming data for wireless devices (12) connected to a wireless electronic data communication network (14) comprising a plurality of access points (APs) (16) dispersed through a facility; from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection; and generating an alert (30) for any AP whose rate of single-AP disconnect events exceeds a predetermined single-AP disconnect rate alert threshold.

### FIELD

The following relates generally to wireless network monitoring arts, wireless network optimization arts, wireless information technology (IT) arts, and related arts.

### BACKGROUND

Wireless networks, such as IEEE 802.11 (Wi-Fi) or WMTS (wireless medical telemetry service) networks allow devices to communicate amongst themselves and/or with network servers while being moved. In applications where connectivity is important (i.e., to be able to ensure the continuity of physiological signals from a patient to a central station in a hospital), it is important that the access points (APs) of the wireless network to which the mobile devices connect are properly positioned in a facility, such that connectivity is easily maintained while a wireless device roams from one AP to another.

The physical locations of two APs can determine the ease with which devices can roam between these APs. Two APs located in near proximity to each other allow a device to connect from one AP to the other without the device first having to go through a phase of weak signals between the each of the APs and the device. If the two APs are located further apart, this roaming becomes more difficult without losing data, to the point in which it may become impossible to roam between them at all.

Laying out a wireless network of APs in a facility is mostly done by hand, using heuristics to determine the position of each AP. If the signal strength would be relatively constant over time, an experienced designer may well make a wireless network with a good performance. However, in many environments, this may not be the case, and signal variability may occur due to radio frequency (RF) interference sources, impact of low battery power in roaming devices, and so forth.

Furthermore, the signal strength of the wireless network depends on the layout and used materials of the facility. Thick concrete walls can block radio signals to a higher degree than wooden walls. This makes it quite difficult to accurately estimate signal strengths that can be obtained between different positions in the facility.

The following discloses certain improvements to overcome these problems and others.

### SUMMARY

In one aspect, a non-transitory computer readable medium stores instructions executable by at least one electronic processor to perform a method of detecting issues with wireless connections. The method includes: receiving Wi-Fi roaming data for wireless devices connected to a wireless electronic data communication network comprising a plurality of access points (APs) dispersed through a facility; from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection; and generating an alert for any AP whose rate of single-AP disconnect events exceeds a predetermined single-AP disconnect rate alert threshold.

In another aspect, a non-transitory computer readable medium stores instructions executable by at least one electronic processor to perform a method of detecting issues with wireless connections. The method includes: receiving Wi-Fi roaming data for wireless devices connected to a wireless electronic data communication network comprising a plurality of access points APs dispersed through a facility; from the received Wi-Fi roaming data, determining single-AP signal strengths for the APs wherein the single-AP signal strength of an AP is an average signal strength of the connections of the AP with wireless devices connected with the AP; and generating an alert for any AP whose single-AP signal strength underruns a predetermined signal strength alert threshold.

In another aspect, a method of detecting issues with wireless connections includes: receiving Wi-Fi roaming data for wireless devices connected to a wireless electronic data communication network comprising a plurality of APs dispersed through a facility; from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection; from the received Wi-Fi roaming data, determining single-AP signal strengths for the APs wherein the single-AP signal strength of an AP is an average signal strength of the connections of the AP with wireless devices connected with the AP; and generating an alert for (i) any AP whose rate of single-AP disconnect events exceeds a predetermined single-AP disconnect rate alert threshold and (ii) any AP whose single-AP signal strength underruns a predetermined signal strength alert threshold.

One advantage resides in providing real-time monitoring of wireless network performance.

Another advantage resides in providing alerts identifying underperformance of specific APs.

Another advantage resides in providing automated AP reconfiguration to attempt to remediate an underperforming AP.

Another advantage resides in providing real-time monitoring of APs of a wireless network that distinguishes AP disconnects from benign events such as disconnects due to a battery being changed out.

Another advantage resides in leveraging existing mobile devices during their normal operation to collect data for providing the real-time monitoring of the wireless network.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an illustrative apparatus for tracking wireless device movement through a facility in accordance with the present disclosure.

FIG. 2 shows an example flow chart of operations suitably performed by the apparatus of FIG. 1.

FIGS. 3-5 show example plots of wireless network behavior for the apparatus of FIG. 1.

### DETAILED DESCRIPTION

The following relates to approaches for automatically detecting issues in the layout of access points (APs) of a wireless network (e.g., IEEE 802.11 or WMTS). These approaches entail modifying the mobile devices to collect information about disconnects and/or signal strength, associated to specific APs or pairs of APs. This information is occasionally transferred to a server-based Application Performance Monitor (APM) via the wireless network. The collected data are analyzed at the server, e.g. using a module of the APM or a separate processing module, to detect single APs that experience frequent disconnects, single APs that experience frequent episodes of low signal strength, and/or AP pairs that have frequent disconnects during roaming between the APs of the pair.

For detecting disconnects, the disclosed systems and methods preferably analyze disconnect events to discard disconnects that are unrelated to wireless network performance Disconnects of duration less than a threshold Tₘᵢₙ are discarded as they may be due to battery changes. Alternatively, if the devices send battery level information to the APM, then a battery change can be detected as an increase in battery level after the disconnect, and that disconnect can be discarded. Similarly, disconnects of duration longer than a threshold Tₘₐₓ can be discarded, as these are likely to be due to the device being placed into standby. Again, alternatively if the devices send information on standby events to the APM then this information can be correlated with disconnect events to discard disconnects due to devices being placed on standby. The disconnects (other than any discarded disconnects) are analyzed on a per-AP basis, and an alert is sent for any AP that is experiencing a high number of disconnects.

In some embodiments disclosed herein, for detecting low signal strength, an average signal strength for each AP is calculated, and an alert is sent for any AP that has too-low average signal strength.

In other embodiments disclosed herein, counts of disconnects for pairs of APs are also collected and analyzed. For example, when roaming from AP₀ to AP₁ a “make-before-break” handover should occur. (A “make-before-break” handover means that the mobile device initially connected to AP₀ connects with AP₁ before breaking its connection with AP₀ to complete the handover, so that the mobile device is never disconnected from the wireless network. In other words, a normal, successful “make-before-break” handover does not include a disconnect event.) However, if the two APs are too far apart, then the device making a handover from AP₀ to AP₁ may disconnect from AP₀ for a time interval before making the connection to AP₁—this is a disconnect event. These disconnect events are determined by analysis of the data collected from the mobile devices, and again an alert is sent for any pair of APs with frequent disconnects during handovers between them.

In some embodiments disclosed herein, automated remediation is also possible. For example, an AP with frequent disconnects and/or low average power could be automatically reconfigured to use a different RF channel, to operate at a different maximum power, or so forth in an effort to remediate the problem. In such embodiments, an advisory alert may be sent at the time the AP is reconfigured, with a subsequent alert being sent if the reconfiguration of the AP fails to resolve the problem as indicated by frequent disconnects and/or low average power continuing after the AP reconfiguration. In a variant, reconfigurations to several different RF channels with associated advisory alerts may be attempted before the final alert is sent. In a further variant, the advisory alerts indicating the AP reconfigurations may be omitted.

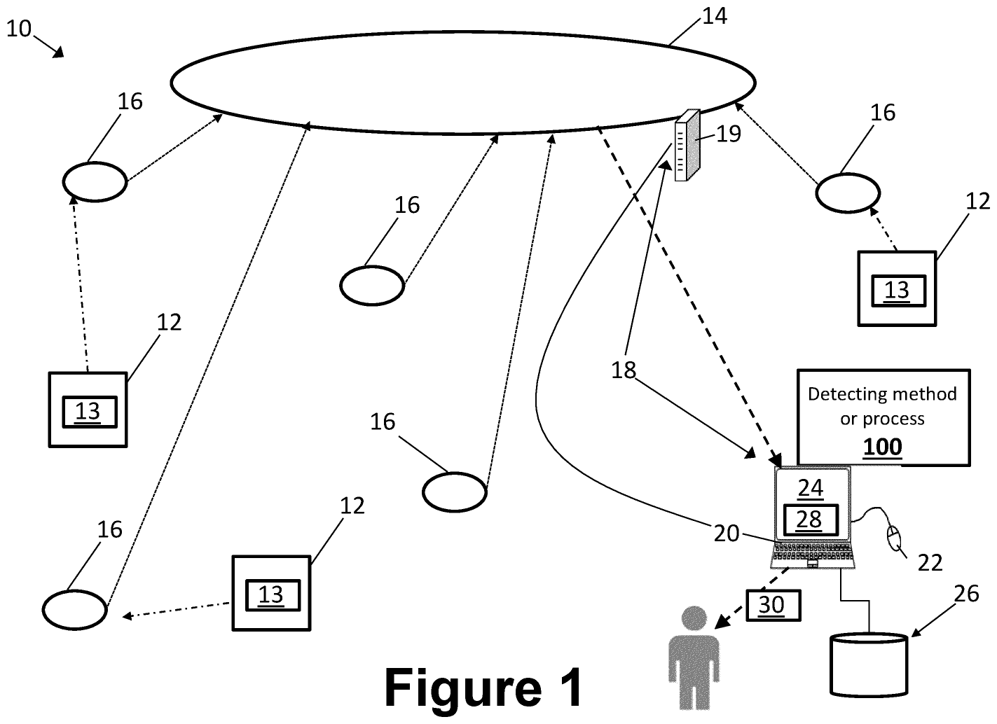

With reference to FIG. 1, an illustrative apparatus 10 is shown for tracking movement of one or more wireless devices 12 (e.g., medical devices) through a facility (e.g., a medical facility). The wireless device(s) 12 can be, for example, a patient monitor, wireless-capable infusion pump, wireless patient ID tag, a dedicated wireless patient tracking sensor, and so forth. The wireless devices 12 are connected to a wireless electronic data communication network 14 (e.g., a Wi-Fi network) of the facility via a plurality of wireless access points (APs) 16 dispersed throughout the facility. Each wireless device 12 can include at least one electronic processor 13 running on-board firmware or software to control operation of the wireless device 12 including controlling device functionality and controlling wireless communication with a connected AP 16 and coordinating handover events in which the wireless device 12 performs a make-before-break handover from one AP to another AP. The device functionality depends upon the type of wireless device 12. For example, in the case of a WMTS or other medical network 14, a given wireless device 12 may be a wireless patient monitor, or a wireless infusion pump, or a wireless patient identification wristband, or so forth. In the case of a general-purpose IEEE 802.11 wireless network 14, a given wireless device 12 may be a cellular telephone, a notebook computer, or so forth. The on-board software or firmware controlling the wireless communication and handovers further provides information to the wireless electronic data communication network 14 regarding disconnect events and signal strength. This information is associated to specific APs 16, either explicitly (e.g., the information sent by the wireless device 12 indicates a disconnect with identification of the AP from which it was disconnected) or implicitly (e.g., the wireless electronic data communication network 14 logs which wireless device(s) are connected with a given AP so that a given timestamped disconnect event can be associated to the AP with which the wireless device was communicating at the time of the disconnect). In addition, the APs 16 may also send information to an Application Performance Monitor (APM) (not shown). Optionally, the on-board software or firmware controlling the wireless communication and handovers further provides additional information such as battery level of the wireless device 12 and/or standby status (that is, timestamped events when the wireless device is switched to/from standby status). It will be appreciated that the various wireless devices 12 may run different software/firmware providing information on disconnect events and/or signal strength in different ways, so long as the information provided by the wireless devices is interpretable by the communication network 14. Moreover, to employ the disclosed approaches for wireless network monitoring, it is not necessary for all wireless devices 12 connected to the network 14 to provide information on disconnects or signal strength. At a minimum, a single wireless device 12 providing this information is sufficient; however, the more wireless devices 12 that provide disconnect and/or signal strength information, the larger the pool of data from which AP performance statistics can be generated.

FIG. 1 also shows an electronic processing device 18, 19 such as an information technology (IT) department workstation associated with an IT department that manages the wireless electronic data communication network 14, an IT server 19 of the IT department, various combinations thereof, or more generally a computer. The server computer 19 may comprise a plurality of server computers, e.g. interconnected to form a server cluster, cloud computing resource, or so forth, to perform more complex computational tasks. The workstation 18 and/or server 19 includes typical components, such as an electronic processor 20 (e.g., a microprocessor), at least one user input device (e.g., a mouse, a keyboard, a trackball, and/or the like) 22, and a display device 24 (e.g. an LCD display, plasma display, cathode ray tube display, and/or so forth). In some embodiments, the display device 24 can be a separate component from the workstation 18, or may include two or more display devices.

The electronic processor 20 is operatively connected with one or more non-transitory storage media 26. The non-transitory storage media 26 may, by way of non-limiting illustrative example, include one or more of a magnetic disk, RAID, or other magnetic storage medium; a solid state drive, flash drive, electronically erasable read-only memory (EEROM) or other electronic memory; an optical disk or other optical storage; various combinations thereof; or so forth; and may be for example a network storage, an internal hard drive of the workstation 18, various combinations thereof, or so forth. It is to be understood that any reference to a non-transitory medium or media 26 herein is to be broadly construed as encompassing a single medium or multiple media of the same or different types. Likewise, the electronic processor 20 may be embodied as a single electronic processor or as two or more electronic processors. Although not explicitly illustrated in FIG. 1, it is contemplated that some portion of the network monitoring disclosed herein may be performed at the processors 13 of the wireless devices 12, in which case the non-transitory storage media 26 may be considered to include the on-board memory of the wireless devices 12 storing the on-board software or firmware of the wireless devices. (For example, some preprocessing of disconnect event data may be performed by the processor 13). The non-transitory storage media 26 stores instructions executable by the at least one electronic processor 20 (where the “at least one electronic processor” may also possibly include the wireless device processors 13 performing some of this processing, as just noted). The instructions include instructions to generate a visualization of a graphical user interface (GUI) 28 for display on the display device 24.

The apparatus 10 is configured as described above to perform a method 100 of detecting issues with wireless connections, such as detecting disconnections between the wireless devices 12 and the APs 16. The non-transitory storage medium 26 stores instructions which are readable and executable by the at least one electronic processor 20 to perform disclosed operations including performing the method or process 100 of detecting issues with wireless connections. In some examples, the method 100 can be computationally complex, and may be advantageously performed at least in part by cloud processing.

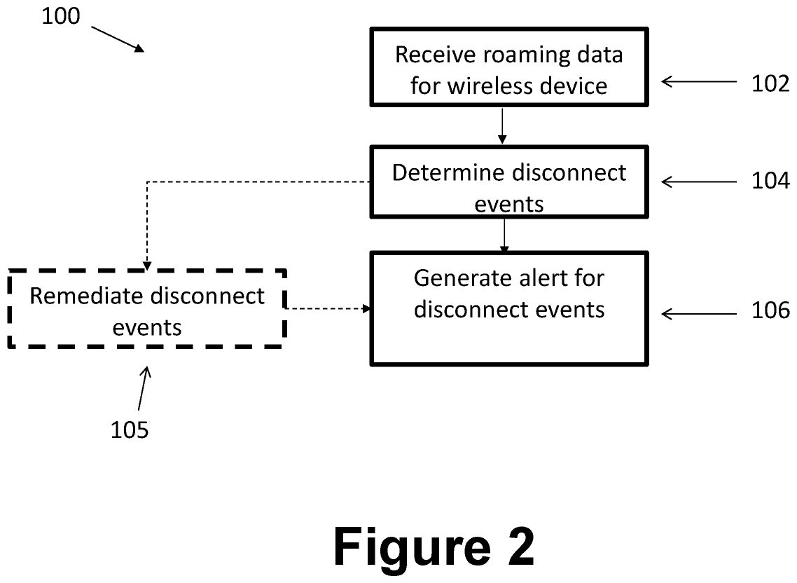

With continuing reference to FIG. 1, and with reference to FIG. 2, an illustrative embodiment of the method 100 of detecting issues with wireless connections is diagrammatically shown as a flowchart. At an operation 102, the workstation 18 is programmed to receive wireless (e.g., Wi-Fi) roaming data for the wireless devices 12 from the APs 16 of the network 14. In some example, the Wi-Fi roaming data is received in real time, while in other examples, the Wi-Fi roaming data is received and stored in the non-transitory computer readable medium 26.

At an operation 104, single-AP disconnect events are determined for the APs 16. A “single-AP disconnect event” for a given AP 16 comprises a disconnection of the AP from a wireless device 12, followed by a reconnection of the given AP with the wireless device without the wireless device connecting to any other AP during a time interval between the disconnection and the reconnection. At an operation 106, an alert 30 is generated for any AP 16 whose rate of single-AP disconnect events exceeds a predetermined single-AP disconnect rate alert threshold. While described in terms of the workstation 18, in some embodiments, the operations 104 and 106 can be performed using the electronic processors 13 of the wireless devices 12 to determine the single-AP disconnect events for the APs 16, and the generating of the alert 30 is performed by the server computer 19.

The determining operation 104 can be performed in a variety of manners. In some embodiments, the determining of the single-AP disconnect events includes discarding any single-AP disconnect event whose time interval between the disconnection and the reconnection falls below a predetermined minimum time threshold. In other embodiments, the received Wi-Fi roaming data from the operation 102 includes data on battery levels for the wireless devices 12. The determining operation 104 of the single-AP disconnect events includes discarding any single-AP disconnect event for which the battery level of the wireless device 12 at the reconnection is higher than a battery level of the wireless device at the disconnection. In further embodiments, the determining of the single-AP disconnect events includes discarding any single-AP disconnect event whose time interval between the disconnection and the reconnection exceeds a predetermined maximum time threshold.

In some embodiments, the received Wi-Fi roaming data from the operation 102 includes data on standby statuses of the wireless devices 12. The determining operation 104 includes discarding any single-AP disconnect event in which the wireless device entered standby status during the time interval between the disconnection and the reconnection.

In other embodiments, as opposed to determining disconnection time intervals, the determining operation 104 includes determining single-AP signal strengths for the APs 16 from the received Wi-Fi roaming data. The single-AP signal strength of an AP 16 is an average signal strength of the connections of the AP with wireless devices 12 connected with the AP. In this embodiment, the alert generation operation 106 includes generating an alert 30 for any AP 16 whose single-AP signal strength underruns a predetermined signal strength alert threshold.

While described herein as single-AP disconnects, the method 100 is applicable to multiple-AP disconnects, which can comprise a disconnection of one AP 16 of the pair a APs from a wireless device 12, followed by a disconnected time interval during which the wireless device is not connected with any AP of the plurality of APs, followed by a connection of the AP with the other AP of the pair of APs. In these embodiments, the determining operation 104 can include determining pairwise disconnect events for pairs of APs 16 from the received Wi-Fi roaming data. The alert generation operation 106 includes generating an alert 30 for any pair of APs whose rate of pairwise disconnect events exceeds a predetermined pairwise disconnect rate alert threshold.

In some embodiments, the method 100 can include a remediation operation 105, which is performed before the alert generation operation 106. This is indicated by the path drawn with dashed lines in FIG. 2. The remediation operation 105 includes performing a remedial action for any AP 16 whose rate of single-AP disconnect events exceeds a predetermined single-AP disconnect rate remediation threshold. One example of a remedial action can include switching a radio frequency (RF) channel of the AP 16. This could be useful to resolve the problem if, for example, disconnects are being caused by local RF interference at the RF channel the AP 16 is currently operating on. Another option is that the signal strength of the AP 16 could be adjusted upward (i.e., to higher signal strength). Typically, adjusting the signal strength upward will reduce disconnects. In yet another option, the signal strength of a neighboring AP 16 may be adjusted downward (i.e. to lower signal strength). This could be useful if the neighboring AP is introducing RF interference. These are merely illustrative remedial actions, and other types of remedial actions are contemplated, such as using different wireless transport protocol parameters. The threshold for the remediation operation 105 is lower than the alert threshold of the alert generation operation 106. Thus, the method 100 will first try to automatically fix the problem, and only if that fails will an alert be issued. Also, although not shown in FIG. 2, it is contemplated to generate an advisory alert 30 in conjunction with the remediation operation 105 which could be useful to inform IT personnel that there may be a concern with the AP.

In other embodiments, between the data receiving operation 102 and the determining option 104, a representation of the connections between the wireless devices 12 and the APs 16 can be displayed via the GUI 28 on the display device 24. For example, each AP 16 can be represented by a node, and the handover events can be represented by lines connecting APs, e.g. with the light weight between any two APs being determined by the number of handover events between the two APs. (Optionally, a connecting line may be shown between two APs only when the number of handover events between those two APs is greater than some minimum value). The disconnect events determined at operation 104 may be annotated to the graphical representation, for example by labeling each line representing handover events between a given pair of APs with a number of disconnect events. Lines between pairs of APs that are experiencing a higher number of disconnect events may additionally or alternatively be highlighted by color, e.g. black lines for lines connecting AP pairs with few or no disconnect events, and yellow and red lines being used for lines connecting AP pairs with progressively higher numbers of disconnects. The user can view this visualization at any time to see visually where disconnects are occurring, and/or the representation may be shown when the alerts 30 are generated at the alert generation 102. In the latter case, the line between the two APs whose excessive disconnect events triggered the alert 30 may be highlighted by a special color, showing the APs and the connecting line as flashing, or so forth. In yet other embodiments, the Wi-Fi roaming data received at the data receiving operation 102 and/or the alerts 30 can additionally or alternatively be input to a service call network to request that a service worker provide adjustment of the APs 16, and/or determine whether the disconnect event is a result of a network connectivity issue or a required service issue.

### EXAMPLE

The following describes in more details the algorithms used in the method 100. The method 100 can provide insight into the APs 16, as well as the relation between pairs of APs to enable the wireless electronic data communication network 14 to be improved, based on the signal strength received by devices and their roaming behavior. This relation is quantified by counting short disconnects of devices between being connected to one AP 16 and being connected again to the same or another AP.

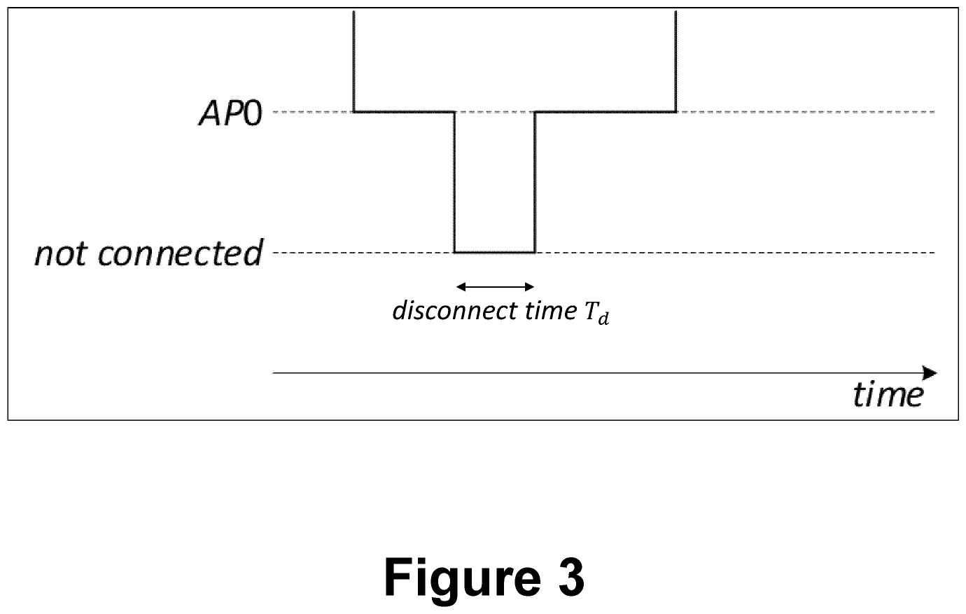

In a first embodiment, disconnects are determined between the wireless device 12 and a single AP 16. FIG. 3 illustrates an example roaming behavior of a wireless device 12, arriving at AP₀ at a certain time, being connected to it for some time, after which it is not connected for a time T_{d} before it connects to AP₀ again. A number of disconnects of any wireless device 12 can be determined from a given AP 16 during a time interval I=[t, t+Δ) that have a duration T_{d}∈[Tₘᵢₙ, Tₘₐₓ). If this number exceeds another threshold N (I, L), where L quantifies the total load, the AP 16 has experienced during this time interval, then the AP is flagged as unreliable for this time interval. The total load can be expressed as the sum of all durations that the wireless devices 12 have been connected to the AP 16 in interval I. If this flagging occurs too often over time during successive intervals, then technical (e.g. IT) personnel is notified by the alert 30 (corresponding to alert operation 106 of FIG. 2) to investigate and solve the problem by, e.g., re-arranging existing APs 16 or inserting additional APs, or removing sources of interference. Without this alert 30, the reliability problem may remain unnoticed and communication may remain impaired. By having this problem solved, communication is improved.

In some situations, short-term disconnects may be the result of battery changes. The Tₘᵢₙ may serve to identify and discard those short disconnects. Another way of discarding these disconnects is to measure the battery level just before and just after the disconnect. If it has increased, there was a battery change, and the disconnect should be discarded. Another case is the state Standby, where the device is in standby and disconnected for a prolonged amount of time. The Tₘₐₓ serves to discard too long disconnects.

In a second embodiment (which is optionally combinable with the first embodiment), a quality of a connection between an AP 16 and a wireless device 12 can be expressed in terms of signal strength, which may change over time. When individual wireless devices 12 experience low signal strength, it should be determined whether a few or many connected wireless devices 12 experience a low signal strength. When this occurs too often during successive time intervals, then technical personnel can be notified by an alert 30 to investigate and solve the problem. Without this alert, the low signal strength may remain unnoticed and communication may remain impaired. By having this problem solved, communication is improved.

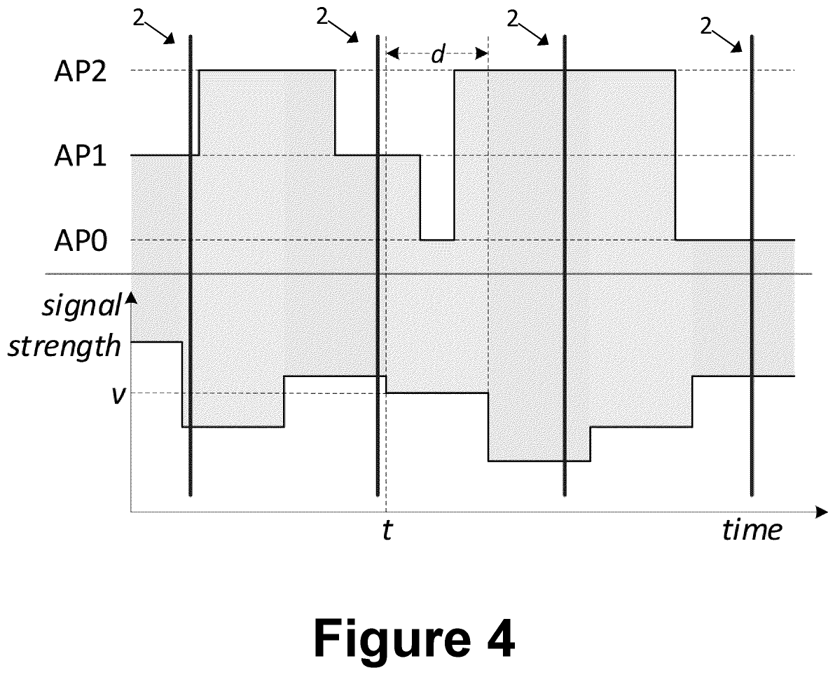

FIG. 4 shows the signal strength as seen from an AP 16 for a single wireless device 12. In a lower portion of the plot shown in FIG. 2, a time-varying signal strength is given, e.g., as a piecewise constant function of time. This has to do with the sampling that occurs to get signal strength values. In an upper portion of the plot shown in FIG. 4, the roaming behavior of the wireless device 12 is given.

Each signal strength v during interval [t, t+d) with one or more APs 16 the wireless device 12 has been connected to is determined during this interval. The total duration d is subdivided into parts corresponding to the connection times. In this example, d is divided in three equal parts of duration d/3, and the signal strength associated with, e.g., AP₁ is encoded as (t, v, d/3) and for AP₀ this is

$$[ t + \frac{d}{3} , v , d / 3 ) .$$

Hence, triples (tᵢⱼₖ, dᵢⱼₖ, vᵢⱼₖ) are recorded for each APi, monitor j, and for k=0, 1, 2, . . . . (It is noted that the division into three equal parts is an example, and other partitioning arrangements are contemplated, based on the exact times during which the wireless device 12 has been connected to the respective on or more APs 16).

For each AP 16, based on the triples, a weighted average of the signal strengths vᵢⱼₖ, is calculated, in which the weights being the individual durations dᵢⱼₖ, over fixed intervals of time, indicated by the lines 2 in FIG. 4. If necessary, durations are further subdivided over two or more of these fixed intervals if they cross one or more of such lines.

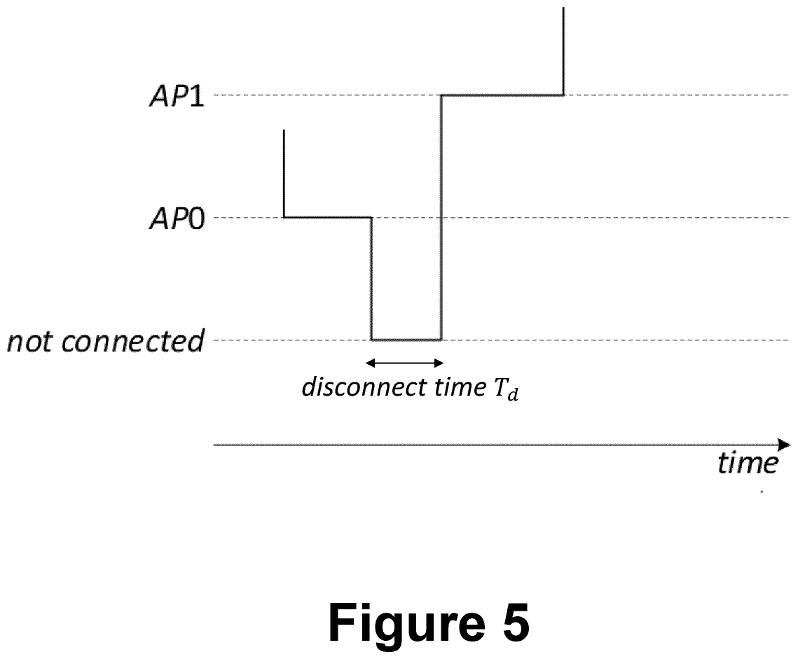

In a third embodiment (which is optionally combinable with the first and/or second embodiments), disconnects from multiple APs 16 can be determined. FIG. 5 shows such an example. Frequent disconnects between pairs of APs 16 can be identified and technical personnel be notified by an alert 30 to investigate and solve the problem by, e.g., re-arranging existing APs or inserting additional APs, or removing sources of interference. Without this alert 30, the reliability problem may remain unnoticed and communication may remain impaired. By having this problem solved, communication is improved.

By analyzing the network 14 of APs 16, weak and problematic spots in the network can be identified, after which the issues can be resolved, leading to a network with a better performance in terms of connectivity and signal strength, which in turn leads to better and more continuous communication between devices. When the optional remediation 105 (see FIG. 2) is provided, the network monitoring can be extended to provide automated wireless network correction.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory computer readable medium storing instructions executable by at least one electronic processor to perform a method of detecting issues with wireless connections, the method comprising:
receiving Wi-Fi roaming data for wireless devices connected to a wireless electronic data communication network comprising a plurality of access points (APs) dispersed through a facility;
from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection; and
generating an alert for any AP whose rate of single-AP disconnect events exceeds a predetermined single-AP disconnect rate alert threshold.

2. The non-transitory computer readable medium of claim 1, wherein the determining of the single-AP disconnect events includes:
discarding any single-AP disconnect event whose time interval between the disconnection and the reconnection falls below a predetermined minimum time threshold.

3. The non-transitory computer readable medium of claim 1, wherein the received Wi-Fi roaming data includes data on battery levels for the wireless devices, and the determining of the single-AP disconnect events includes:
discarding any single-AP disconnect event for which the battery level of the wireless device at the reconnection is higher than a battery level of the wireless device at the disconnection.

4. The non-transitory computer readable medium of claim 1, wherein the determining of the single-AP disconnect events includes:
discarding any single-AP disconnect event whose time interval between the disconnection and the reconnection exceeds a predetermined maximum time threshold.

5. The non-transitory computer readable medium of claim 1, wherein the received Wi-Fi roaming data includes data on standby statuses of the wireless devices, and the determining of the single-AP disconnect events includes:
discarding any single-AP disconnect event in which the wireless device entered standby status during the time interval between the disconnection and the reconnection.

6. The non-transitory computer readable medium of claim 1, wherein the method further includes:
from the received Wi-Fi roaming data, determining single-AP signal strengths for the APs, wherein the single-AP signal strength of an AP is an average signal strength of the connections of the AP with wireless devices connected with the AP;
generating an alert for any AP whose single-AP signal strength underruns a predetermined signal strength alert threshold.

7. The non-transitory computer readable medium of claim 1, wherein the method further includes:
from the received Wi-Fi roaming data, determining pairwise disconnect events for pairs of APs wherein a pairwise disconnect event for a pair of APs comprises a disconnection of one AP of the pair of APs from a wireless device followed by a disconnected time interval during which the wireless device is not connected with any AP of the plurality of APs followed by a connection of the AP with the other AP of the pair of APs; and
generating an alert for any pair of APs whose rate of pairwise disconnect events exceeds a predetermined pairwise disconnect rate alert threshold.

8. The non-transitory computer readable medium of claim 1, wherein the method further includes:
performing a remedial action for any AP whose rate of single-AP disconnect events exceeds a predetermined single-AP disconnect rate remediation threshold.

9. The non-transitory computer readable medium of claim 8, wherein the performing of the remedial action includes switching a radio frequency (RF) channel of the AP.

10. The non-transitory computer readable medium of claim 1, wherein the at least one electronic processor includes electronic processors of the wireless devices and a server computer, and the determining single-AP disconnect events for the APs is performed by the electronic processors of the wireless devices and the generating of the alert is performed by the server computer.

11. The non-transitory computer readable medium of claim 1, wherein the method further includes:
displaying, on a display device, a representation of connections between the wireless devices and the APs.

12. The non-transitory computer readable medium of claim 1, wherein the method further includes:
inputting at least one of the received Wi-Fi roaming data and the alert to request at least one of: (i) an adjustment of the APs and a determination of whether the determined disconnect event is a result of a network connectivity issue or a required service issue.

13. A non-transitory computer readable medium storing instructions executable by at least one electronic processor to perform a method of detecting issues with wireless connections, the method comprising:
receiving Wi-Fi roaming data for wireless devices connected to a wireless electronic data communication network comprising a plurality of access points (APs) dispersed through a facility;
from the received Wi-Fi roaming data, determining single-AP signal strengths for the APs wherein the single-AP signal strength of an AP is an average signal strength of the connections of the AP with wireless devices connected with the AP; and
generating an alert for any AP whose single-AP signal strength underruns a predetermined signal strength alert threshold.

14. The non-transitory computer readable medium of claim 13, wherein the method further includes:
from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection; and
generating an alert for any AP whose rate of single-AP disconnect events exceeds a predetermined single-AP disconnect rate alert threshold.

15. The non-transitory computer readable medium of claim 14, wherein the determining of the single-AP disconnect events includes:
discarding any single-AP disconnect event whose time interval between the disconnection and the reconnection falls below a predetermined minimum time threshold.

16. The non-transitory computer readable medium of claim 14, wherein the received Wi-Fi roaming data includes data on battery levels for the wireless devices, and the determining of the single-AP disconnect events includes:
discarding any single-AP disconnect event for which the battery level of the wireless device at the reconnection is higher than a battery level of the wireless device at the disconnection.

17. The non-transitory computer readable medium of claim 14, wherein the determining of the single-AP disconnect events includes:
discarding any single-AP disconnect event whose time interval between the disconnection and the reconnection exceeds a predetermined maximum time threshold.

18. The non-transitory computer readable medium of claim 14, wherein the received Wi-Fi roaming data includes data on standby statuses of the wireless devices, and the determining of the single-AP disconnect events includes:
discarding any single-AP disconnect event in which the wireless device entered standby status during the time interval between the disconnection and the reconnection.

19. The non-transitory computer readable medium of claim 13, wherein the method further includes:
from the received Wi-Fi roaming data, determining pairwise disconnect events for pairs of APs wherein a pairwise disconnect event for a pair of APs comprises a disconnection of one AP of the pair of APs from a wireless device followed by a disconnected time interval during which the wireless device is not connected with any AP of the plurality of APs followed by a connection of the AP with the other AP of the pair of APs; and
generating an alert for any pair of APs whose rate of pairwise disconnect events exceeds a predetermined pairwise disconnect rate alert threshold.

20. The non-transitory computer readable medium of claim 13, wherein the method further includes:
performing a remedial action for any AP whose rate of single-AP disconnect events exceeds a predetermined single-AP disconnect rate remediation threshold;
wherein the performing of the remedial action includes switching a radio frequency (RF) channel of the AP.

21. The non-transitory computer readable medium of claim 13, wherein the at least one electronic processor includes electronic processors of the wireless devices and a server computer, the determining single-AP disconnect events for the APs is performed by the electronic processors of the wireless devices and the generating of the alert is performed by the server computer.

22. A method of detecting issues with wireless connections, the method comprising:
receiving Wi-Fi roaming data for wireless devices connected to a wireless electronic data communication network comprising a plurality of access points (APs) dispersed through a facility;
from the received Wi-Fi roaming data, determining single-AP disconnect events for the APs wherein a single-AP disconnect event for an AP comprises a disconnection of the AP from a wireless device followed by a reconnection of the AP with the wireless device without the wireless device connecting to any other AP during a time interval between the disconnection and the reconnection;
from the received Wi-Fi roaming data, determining single-AP signal strengths for the APs wherein the single-AP signal strength of an AP is an average signal strength of the connections of the AP with wireless devices connected with the AP; and
generating an alert for (i) any AP whose rate of single-AP disconnect events exceeds a predetermined single-AP disconnect rate alert threshold and (ii) any AP whose single-AP signal strength underruns a predetermined signal strength alert threshold.
